(19) United States
(12) Patent Application Publication
(10) Pub. No.: US 2026/0226874 A1
(43) Pub. Date: Aug. 6, 2026

(54) VEHICLE

(71) Applicant: TOYOTA JIDOSHA KABUSHIKI KAISHA, Toyota-shi (JP)

(72) Inventor: Sho FUJIWARA, Toyota-shi (JP)

(21) Appl. No.: 19/373,732

(22) Filed: Oct. 30, 2025

(30) Foreign Application Priority Data
Feb. 3, 2025 (JP) 2025-015890

(51) Int. Cl. F02M 21/06; F02D 41/00; F02M 21/02

(52) U.S. Cl. CPC F02M 21/06; F02D 41/0027; F02M 21/0206; F02M 21/0242; F02M 21/0245; F02D 2200/10; F02D 2200/501

(57) ABSTRACT

A vehicle includes an internal combustion engine that uses hydrogen as fuel, a fuel tank that stores liquid hydrogen, and a vaporizer that vaporizes the liquid hydrogen stored in the fuel tank. The vehicle further includes multiple heat exchangers that exchange heat with the vaporizer, passages that connect the vaporizer to the respective heat exchangers, a flow rate control mechanism that controls a flow rate of a heating medium flowing through each passage, and a controller that controls the flow rate control mechanism. The heat exchangers include a radiator and a waste heat recovery device. The radiator is an engine heat exchanger that exchanges heat with a fluid flowing through the internal combustion engine. The waste heat recovery device exchanges heat with exhaust gas of the internal combustion engine.

### CROSS-REFERENCE TO RELATED APPLICATIONS

This application is based upon and claims the benefit of priority from Japanese Patent Application No. 2025-015890, filed on February 3, 2025, the entire contents of which are incorporated herein by reference.

### BACKGROUND

### 1. Field

The present disclosure relates to a vehicle.

### 2. Description of Related Art

For example, JP2024-118121A discloses a vehicle provided with an internal combustion engine that uses hydrogen as fuel and a vaporizer that vaporizes liquid hydrogen stored in a fuel tank.

When heat generated by the internal combustion engine is used as a heat source for the vaporizer, warm-up of the internal combustion engine tends to be inhibited. Accordingly, heat exchange in the vaporizer may adversely affect the warm-up of the internal combustion engine.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a vehicle includes an internal combustion engine that uses hydrogen as fuel, a fuel tank that stores liquid hydrogen, a vaporizer that vaporizes the liquid hydrogen stored in the fuel tank, multiple heat exchangers that exchange heat with the vaporizer, passages that connect the vaporizer to the respective heat exchangers, a flow rate control mechanism that controls a flow rate of a heating medium flowing through each passage, and a controller that controls the flow rate control mechanism. The heat exchangers include an engine heat exchanger that exchanges heat with a fluid flowing through the internal combustion engine, and a waste heat recovery device that exchanges heat with exhaust gas of the internal combustion engine.

Other features and aspects will be apparent from the following detailed description, the drawings, and the claims.

### BRIEF DESCRIPTION OF THE DRAWINGS

FIG. 1 is a schematic diagram showing a configuration of a vehicle according to a first embodiment.

FIG. 2 is a table showing respective operating states of pumps and valves in the first embodiment.

FIG. 3 is a schematic diagram showing a configuration of a vehicle according to a second embodiment.

FIG. 4 is a table showing operating states of a valve in the second embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### First Embodiment

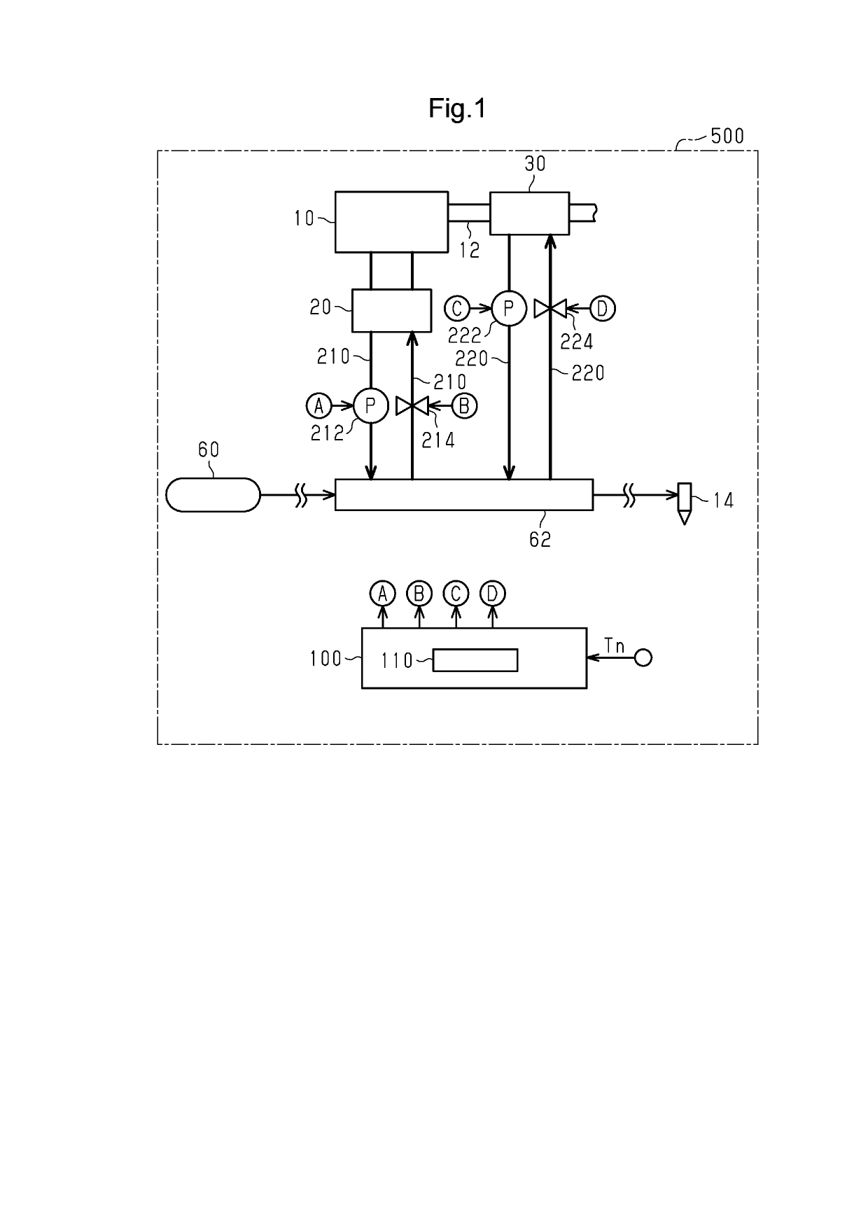

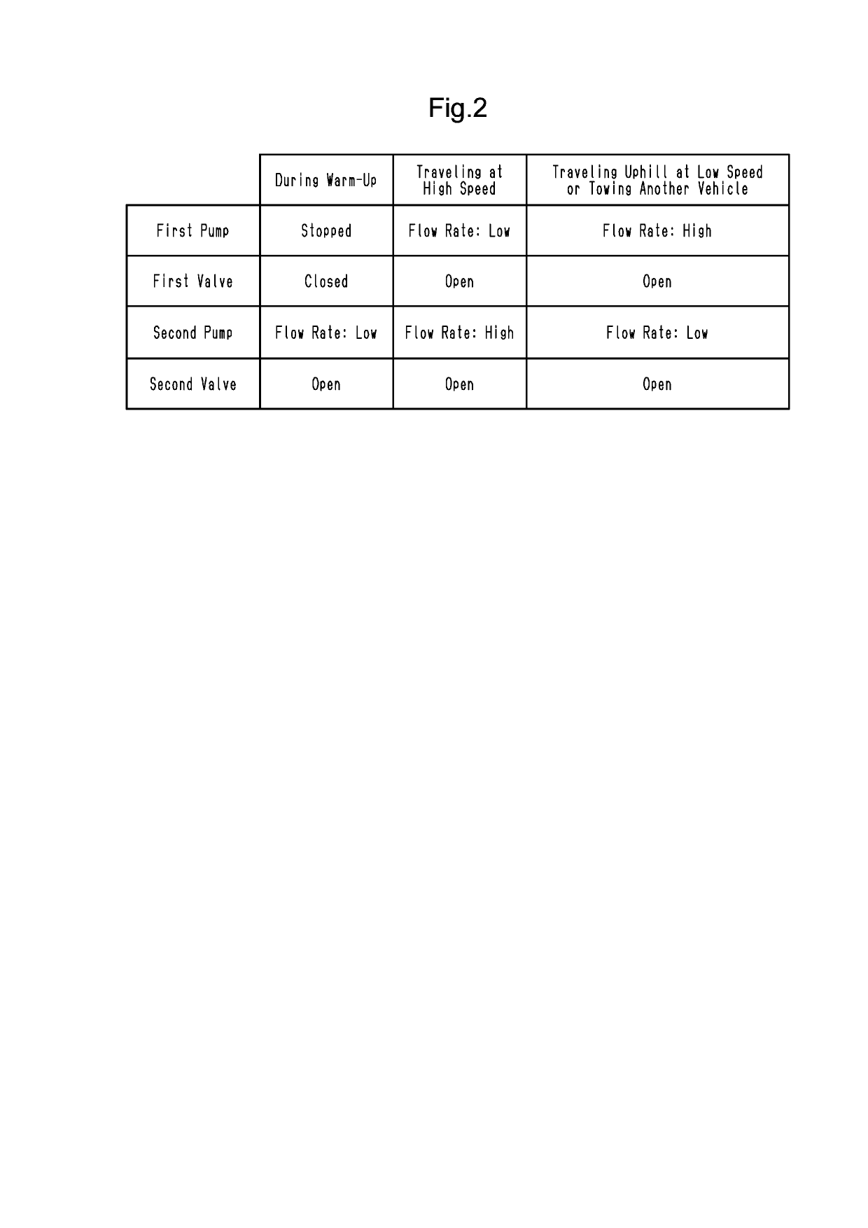

A vehicle according to a first embodiment will now be described with reference to FIGS. 1 and 2.

### Configuration of Vehicle

As shown in FIG. 1, the vehicle 500 includes an internal combustion engine 10, a fuel tank 60, and a vaporizer 62. The vehicle 500 includes multiple heat exchangers, passages that respectively connect the vaporizer and the multiple heat exchangers, a flow rate control mechanism that controls the flow rate of the heat medium flowing through each passage, and the controller 100 that controls the flow rate control mechanism.

The fuel of the internal combustion engine 10 is hydrogen.

The fuel tank 60 stores cooled liquid hydrogen.

The vaporizer 62 is a heat exchanger that heats and vaporizes liquid hydrogen supplied from the fuel tank 60 by exchanging heat between the liquid hydrogen and cooling water serving as a heating medium. The hydrogen vaporized by the vaporizer 62 is supplied to the fuel injection valve 14 of the internal combustion engine 10.

The multiple heat exchangers include an engine heat exchanger that exchanges heat with cooling water, which is a fluid flowing through the internal combustion engine 10, and a waste heat recovery device 30 that exchanges heat with the exhaust gas of the internal combustion engine 10.

The engine heat exchanger is, for example, a radiator 20 that cools cooling water of the internal combustion engine 10 with ram air.

The waste heat recovery device 30 is provided in the exhaust passage 12 of the internal combustion engine 10. The waste heat recovery device 30 performs heat exchange between the cooling water as a heat medium and the exhaust gas.

The passage includes a first passage 210 connected between the radiator 20 and the vaporizer 62 so that the cooling water as the heat medium circulates and flows therethrough, and a second passage 220 connected between the waste heat recovery device 30 and the vaporizer 62 so that the cooling water as the heat medium circulates and flows therethrough.

The first passage 210 is provided with a first pump 212 that circulates the cooling water between the radiator 20 and the vaporizer 62, and a first valve 214 that selectively opens and closes the first passage 210.

The second passage 220 is provided with a second pump 222 that circulates the cooling water between the waste heat recovery device 30 and the vaporizer 62, and a second valve 224 that selectively opens and closes the second passage 220.

The flow rate control mechanism includes a first pump 212, a first valve 214, a second pump 222, and a second valve 224.

The controller 100 includes processing circuitry 110. The processing circuitry 110 includes a CPU that executes processing in accordance with a program and a ROM in which the program is stored. The CPU executes a program stored in the ROM to perform various kinds of control.

The controller 100 acquires the temperature Tn of cooling water flowing through each of the above-described heat exchangers. The processing circuitry 110 of the controller 100 acquires the operation state of the internal combustion engine 10 and the traveling state of the vehicle 500. The operation state of the internal combustion engine 10 acquired by the processing circuitry 110 is, for example, an engine load state or whether the internal combustion engine 10 is being warmed up. The traveling state of the vehicle 500 acquired by the processing circuitry 110 is, for example, whether the vehicle is traveling at a high speed, whether the vehicle is traveling uphill at a low speed, or whether the vehicle is towing another vehicle or the like. The processing circuitry 110 executes processing for controlling the first pump 212, the first valve 214, the second pump 222, and the second valve 224 in accordance with the acquired operating state of the internal combustion engine 10 and the acquired traveling state of the vehicle 500.

Pump and Valve Control Performed by Processing Circuitry

As shown in FIG. 2, through the processing executed by the processing circuitry 110, the first pump 212, the first valve 214, the second pump 222, and the second valve 224 are controlled to states corresponding to the operating state of the internal combustion engine 10 and the traveling state of the vehicle 500. An example of such control will be described below.

When the internal combustion engine 10 is being warmed up, the processing circuitry 110 stops the driving of the first pump 212 and closes the first valve 214. When the internal combustion engine 10 is being warmed up, the processing circuitry 110 drives the second pump 222 and opens the second valve 224 so that the displacement of the second pump 222 becomes a predetermined low flow rate S2. The low flow rate S2 is, for example, a flow rate lower than the displacement of the second pump 222 set during high-speed traveling to be described later.

When the vehicle 500 is traveling at a high speed, the processing circuitry 110 drives the first pump 212 and opens the first valve 214 so that the displacement of the first pump 212 becomes a predetermined low flow rate S1. The low flow rate S1 is a flow rate lower than the displacement of the first pump 212 that is set when the vehicle 500 is not traveling at high speed. For example, the low flow rate S1 is a flow rate lower than a displacement of the first pump 212 set in a high load state described later. When the vehicle 500 is traveling at a high speed, the processing circuitry 110 drives the second pump 222 and opens the second valve 224 so that the displacement of the second pump 222 becomes a predetermined high flow rate L2. The high flow rate L2 is, for example, a flow rate higher than the low flow rate S2.

When the vehicle 500 is traveling uphill at a low speed or when the vehicle 500 is towing another vehicle or the like, that is, when the internal combustion engine 10 is in a high load state, the processing circuitry 110 drives the first pump 212 so that the displacement of the first pump 212 becomes a predetermined high flow rate L1. Further, the processing circuitry 110 opens the first valve 214. The high flow rate L1 is a flow rate higher than the low flow rate S1. Further, when the vehicle 500 is traveling uphill at a low speed or when the vehicle 500 is towing another vehicle or the like, that is, when the internal combustion engine 10 is in a high load state, the processing circuitry 110 drives the second pump 222 so that the displacement of the second pump 222 becomes a predetermined low flow rate S2. Further, the processing circuitry 110 opens the second valve 224. The low flow rate S2 at this time is the same as the low flow rate S2 described above, but is not necessarily the same, and may be different.

### Operation of the Present Embodiment

During the warm-up operation of the internal combustion engine 10, the first valve 214 is closed and the first pump 212 is stopped. Therefore, no heat is transferred between the radiator 20 and the vaporizer 62. On the other hand, the second valve 224 is opened and the second pump 222 is driven at the low flow rate S2. Therefore, since heat is transferred from the waste heat recovery device 30 to the vaporizer 62, the liquid hydrogen is vaporized in the vaporizer 62 using the heat of the exhaust gas.

As described above, the processing circuitry 110 executes a process of controlling the flow rate control mechanism such that the amount of heat transferred between the vaporizer 62 and the waste heat recovery device 30 is larger than the amount of heat transferred between the vaporizer 62 and the radiator 20 during warm-up of the internal combustion engine 10.

When the vehicle 500 is running at a high speed, the first valve 214 is opened and the first pump 212 is driven at a low flow rate S1. Therefore, heat is transferred from the radiator 20 to the vaporizer 62 to cool the radiator 20, and the liquid hydrogen is vaporized in the vaporizer 62 by using the engine heat. Further, the second valve 224 is opened, and the second pump 222 is driven at the high flow rate L2. Therefore, since the amount of heat transferred from the waste heat recovery device 30 to the vaporizer 62 increases, the vaporizer 62 vaporizes the liquid hydrogen mainly using the heat of the exhaust gas.

As described above, when the vehicle 500 is traveling at a high speed, the processing circuitry 110 controls the first valve 214 and the second valve 224 such that the vaporizer 62 exchanges heat with both the waste heat recovery device 30 and the radiator 20. Also, the processing circuitry 110 executes a process of controlling the displacement of the first pump 212 such that the displacement of the first pump 212 is smaller than when the vehicle 500 is not traveling at a high speed

When the internal combustion engine 10 is in a high load state, the first valve 214 is opened and the first pump 212 is driven at a high flow rate L1. Therefore, heat is transferred from the radiator 20 to the vaporizer 62 to cool the radiator 20, and the liquid hydrogen is vaporized in the vaporizer 62 by using the engine heat. Further, the second valve 224 is opened and the second pump 222 is driven at the low flow rate S2. Therefore, the amount of heat transferred from the waste heat recovery device 30 to the vaporizer 62 is reduced, and the liquid hydrogen is vaporized mainly using the engine heat in the vaporizer 62.

As described above, the processing circuitry 110 executes a process of controlling the flow rate control mechanism such that the amount of heat transferred between the vaporizer 62 and the radiator 20 is larger than the amount of heat transferred between the vaporizer 62 and the waste heat recovery device 30 when the internal combustion engine 10 is in a high load state.

### Advantages of the Present Embodiment

(1-1) The vehicle 500 includes the internal combustion engine 10, which uses hydrogen as fuel, the fuel tank 60, which stores liquid hydrogen, and the vaporizer 62, which vaporizes the liquid hydrogen stored in the fuel tank 60. The vehicle 500 includes the heat exchangers, which exchange heat with the vaporizer 62, and the first passage 210 and the second passage 220, which connect the vaporizer 62 to the respective heat exchangers. The vehicle 500 includes the flow rate control mechanism, which controls the flow rate of the heating medium flowing through the first passage 210 and the second passage 220. The flow rate control mechanism includes the first pump 212, the first valve 214, the second pump 222, and the second valve 224. The vehicle 500 includes the controller 100, which controls the flow rate control mechanism. The heat exchangers include the radiator 20 and the waste heat recovery device 30. The radiator 20 is an engine heat exchanger that exchanges heat with the fluid flowing through the internal combustion engine 10. The waste heat recovery device 30 exchanges heat with exhaust gas of the internal combustion engine 10.

Therefore, as a heat source of the vaporizer 62, the heat of the exhaust gas can be used in addition to the heat generated in the internal combustion engine 10. Therefore, during the warm-up of the internal combustion engine 10, the liquid hydrogen can be vaporized by using the heat of the exhaust gas, so that the influence of the heat exchange in the vaporizer 62 on the warm-up of the internal combustion engine 10 can be suppressed.

(1-2) Further, cooling of the internal combustion engine 10 is promoted by heat exchange between the vaporizer 62 and the radiator 20. Therefore, heat management in the vehicle 500 using the heat exchanger can be appropriately performed.

(1-3) The controller 100 includes the processing circuitry 110. During the warm-up of the internal combustion engine 10, the processing circuitry 110 executes a process of controlling the flow rate control mechanism such that the amount of heat transferred between the vaporizer 62 and the waste heat recovery device 30 is larger than the amount of heat transferred between the vaporizer 62 and the radiator 20.

By executing such a process, the vaporization of the liquid hydrogen using the heat of the exhaust gas is prioritized during the warm-up of the internal combustion engine 10, so that the heat generated in the internal combustion engine 10 can be used for the warm-up of the internal combustion engine 10.

(1-4) The controller 100 includes the processing circuitry 110. When the internal combustion engine 10 is in a high load state, the processing circuitry 110 executes a process of controlling the flow rate control mechanism such that the amount of heat transferred between the vaporizer 62 and the radiator 20 is larger than the amount of heat transferred between the vaporizer 62 and the waste heat recovery device 30.

When the internal combustion engine 10 is in the high load state and the heat radiation demand of the engine increases, the amount of heat of the engine radiated via the vaporizer 62 increases by the execution of such processing. Therefore, the amount of heat radiated from the engine can be increased.

(1-5) The engine heat exchanger is the radiator 20 that cools the cooling water of the internal combustion engine 10 with ram air. The flow rate control mechanism includes a first valve 214 which opens and closes the first passage 210, a second valve 224 which opens and closes the second passage 220, and a first pump 212 which is provided in the first passage 210 which connects the vaporizer 62 and the radiator 20. The controller 100 includes a processing circuitry 110. When the vehicle 500 is traveling at high speed, the processing circuitry 110 controls the first valve 214 and the second valve 224 such that the vaporizer 62 exchanges heat with both the waste heat recovery device 30 and the radiator 20. Also, the processing circuitry 110 executes a process of controlling the displacement of the first pump 212 such that the displacement of the first pump 212 is smaller than when the vehicle 500 is not traveling at a high speed

When the vehicle 500 is traveling at a high speed, the amount of heat radiated from the radiator 20 increases due to ram air. Therefore, when heat is excessively transferred from the radiator 20 to the vaporizer 62 during high-speed traveling, the internal combustion engine 10 may be excessively cooled. In this regard, in the present embodiment, when the vehicle 500 is traveling at a high speed, the first valve 214 and the second valve 224 are controlled such that the vaporizer 62 exchanges heat with both the waste heat recovery device 30 and the radiator 20. Therefore, the liquid hydrogen is vaporized in the vaporizer 62. The displacement of the first pump 212 provided in the first passage 210 connecting the vaporizer 62 and the radiator 20 is smaller than that in the case where the vehicle 500 is not traveling at high speed. Therefore, heat transfer from the radiator 20 to the vaporizer 62 is suppressed. Therefore, excessive cooling of the internal combustion engine 10 during high-speed traveling can be suppressed.

### Second Embodiment

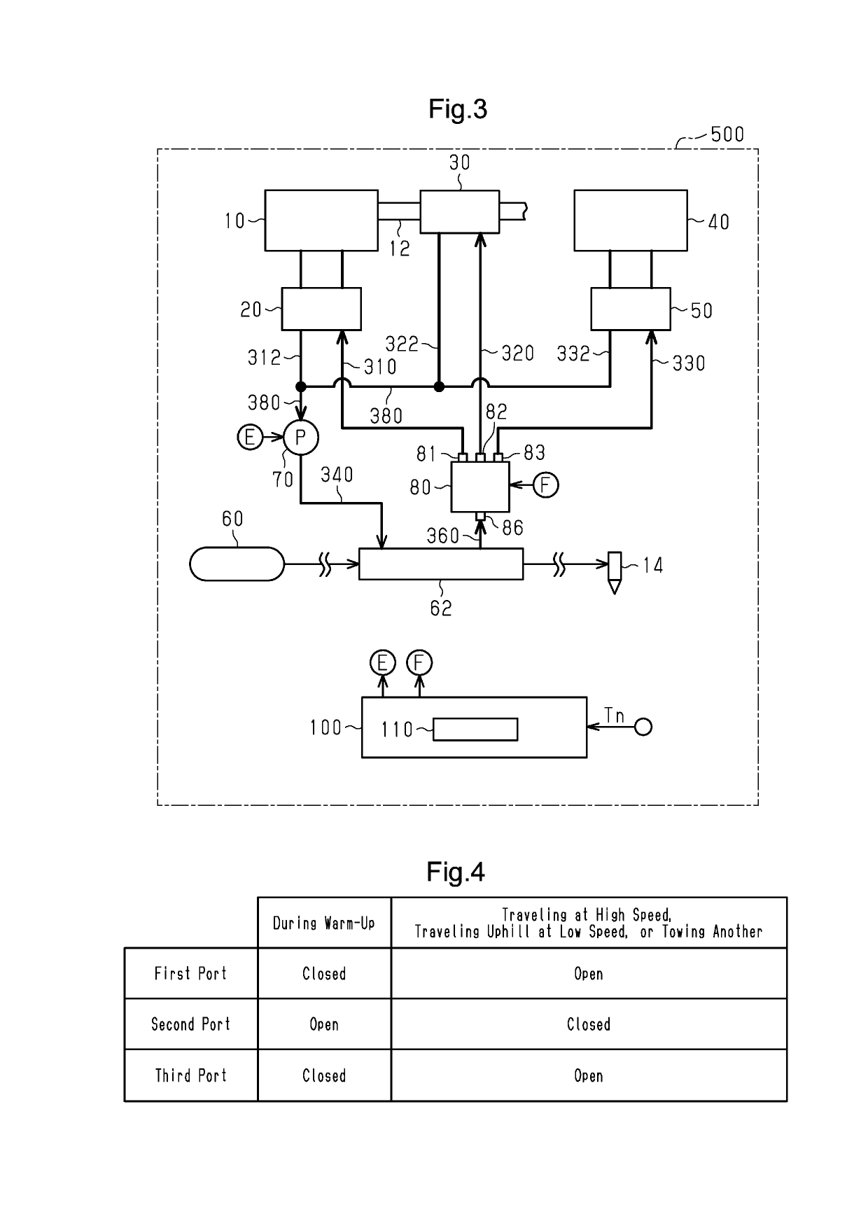

A vehicle according to a second embodiment will now be described with reference to FIGS. 3 and 4. In this embodiment, members and structures having the same functions as those in the first embodiment are denoted by the same reference numerals, and a detailed description thereof will be omitted.

### Configuration of Vehicle

As shown in FIG. 3, the vehicle 500 includes a radiator 20 that is an engine heat exchanger, a waste heat recovery device 30, and an oil cooler 50 that is a drive system heat exchanger. The oil cooler 50 performs heat exchange between the lubricating oil supplied to the transmission 40, which is a drive system mechanism of the vehicle 500, and the coolant, which is a heat medium.

The vehicle 500 includes a passage that connects the vaporizer to each of the multiple heat exchangers and through which cooling water as a heat medium flows, a flow rate control mechanism that controls the flow rate of the heat medium flowing through each passage, and the controller 100 that controls the flow rate control mechanism.

The passage includes a first passage 312 connected to the radiator 20, a second passage 322 connected to the waste heat recovery device 30, and a third passage 332 connected to the oil cooler 50. The passage includes a suction passage 380 that connects each of the first passage 312, the second passage 322, and the third passage 332 to the suction port of the pump 70, and a discharge passage 340 that connects the discharge port of the pump 70 to the vaporizer 62. The driving of the pump 70 is controlled so as to achieve a predetermined displacement during the operation of the internal combustion engine 10. The passages include an inlet passage 360 connecting the vaporizer 62 and the inlet port 86 of the multifunction valve 80, a first outlet passage 310, a second outlet passage 320, and a third outlet passage 330.

The multifunction valve 80 is a flow rate control mechanism that controls the flow rate of the heat medium flowing through each passage. The multifunction valve 80 is a valve with three outlet ports, a first port 81, a second port 82 and a third port 83. In the multifunction valve 80, the outlet port communicating with the inlet port 86 is changed by changing the position of the valve body. The first outlet passage 310 is connected to the first port 81 and the radiator 20. The second outlet passage 320 is connected to the second port 82 and the waste heat recovery device 30. The third outlet passage 330 is connected to the third port 83 and the oil cooler 50.

The processing circuitry 110 of the controller 100 acquires the operation state of the internal combustion engine 10 and the traveling state of the vehicle 500. The operation state of the internal combustion engine 10 acquired by the processing circuitry 110 is, for example, an engine load state or whether the internal combustion engine 10 is being warmed up. The traveling state of the vehicle 500 acquired by the processing circuitry 110 is, for example, whether the vehicle is traveling at a high speed, whether the vehicle is traveling uphill at a low speed, or whether the vehicle is towing another vehicle or the like. Then, the processing circuitry 110 executes a process for controlling the multifunction valve 80 in accordance with the acquired operating state of the internal combustion engine 10 and the acquired traveling state of the vehicle 500.

Control of a Multifunctional Valve Performed by Processing Circuitry

As shown in FIG. 4, the multifunction valve 80 is controlled to a state corresponding to the operating state of the internal combustion engine 10 and the traveling state of the vehicle 500 through the processing executed by the processing circuitry 110. An example of such control will be described below.

When the internal combustion engine 10 is being warmed up, the processing circuitry 110 drives the multifunction valve 80 such that both the first port 81 and the third port 83 are closed and the second port 82 is opened.

When the vehicle 500 is traveling at a high speed, when the vehicle 500 is traveling uphill at a low speed, or when the vehicle 500 is towing another vehicle or the like, that is, when the internal combustion engine 10 is in a high load state, the processing circuitry 110 drives the multifunction valve 80 so that the state of the multifunction valve 80 is as follows. That is, the processing circuitry 110 drives the multifunction valve 80 such that both the first port 81 and the third port 83 are opened and the second port 82 is closed.

### Operation of the Present Embodiment

During the warm-up operation of the internal combustion engine 10, the multifunction valve 80 is driven such that both the first port 81 and the third port 83 are closed and the second port 82 is opened. Therefore, the flow rate of the first outlet passage 310 connected to the radiator 20 and the flow rate of the third outlet passage 330 connected to the oil cooler 50 are both 0. On the other hand, the flow rate of the second outlet passage 320 connected to the waste heat recovery device 30 becomes a flow rate corresponding to the displacement of the pump 70. Therefore, heat is not transferred between the radiator 20 and the vaporizer 62. Heat is not transferred between the oil cooler 50 and the vaporizer 62. On the other hand, since the heat is transferred from the waste heat recovery device 30 to the vaporizer 62, the liquid hydrogen is vaporized in the vaporizer 62 using the heat of the exhaust gas.

In this way, during the warm-up of the internal combustion engine 10, the processing circuitry 110 executes the process of controlling the multifunction valve 80 such that the amount of heat that moves between the vaporizer 62 and the waste heat recovery device 30 is larger than the amount of heat that moves between the radiator 20 and the oil cooler 50, and the vaporizer 62.

Further, when the internal combustion engine 10 is in a high load state, the multifunction valve 80 is driven so that both the first port 81 and the third port 83 are opened and the second port 82 is closed. Therefore, the flow rate of the first outlet passage 310 connected to the radiator 20 and the flow rate of the third outlet passage 330 connected to the oil cooler 50 become flow rates corresponding to the displacement of the pump 70. On the other hand, the flow rate of the second outlet passage 320 connected to the waste heat recovery device 30 becomes 0. Therefore, heat is transferred from the radiator 20 to the vaporizer 62. Further, heat is also transferred from the oil cooler 50 to the vaporizer 62. On the other hand, heat is not transferred between the waste heat recovery device 30 and the vaporizer 62. Therefore, in the vaporizer 62, the liquid hydrogen is vaporized by using the engine heat and the heat generated in the drive system.

In this way, the processing circuitry 110 executes the following processing when the internal combustion engine 10 is in the high load state. That is, the processing circuitry 110 executes a process of controlling the multifunction valve 80 such that the amount of heat transferred between the radiator 20 and the oil cooler 50 and the vaporizer 62 is larger than the amount of heat transferred between the vaporizer 62 and the waste heat recovery device 30.

### Advantages of the Present Embodiment

(2-1) The vehicle 500 includes the internal combustion engine 10 that uses hydrogen as fuel, the fuel tank 60 that stores liquid hydrogen, and the vaporizer 62 that vaporizes the liquid hydrogen stored in the fuel tank 60. The vehicle 500 includes multiple heat exchangers that exchange heat with the vaporizer 62, and the above-described passages that respectively connect the vaporizer 62 and the multiple heat exchangers. The vehicle 500 includes a multifunction valve 80 that is a flow rate control mechanism for controlling the flow rate of the heat medium flowing through each passage. The vehicle 500 includes a controller 100 that controls the multifunction valve 80. The heat exchangers include the radiator 20 and the waste heat recovery device 30. The radiator 20 is an engine heat exchanger that exchanges heat with the fluid flowing through the internal combustion engine 10. The waste heat recovery device 30 exchanges heat with exhaust gas of the internal combustion engine 10.

Therefore, as a heat source of the vaporizer 62, the heat of the exhaust gas can be used in addition to the heat generated in the internal combustion engine 10. Therefore, during the warm-up of the internal combustion engine 10, the liquid hydrogen can be vaporized by using the heat of the exhaust gas, so that the influence of the heat exchange in the vaporizer 62 on the warm-up of the internal combustion engine 10 can be suppressed.

(2-2) The cooling of the internal combustion engine 10 is promoted by the heat exchange between the vaporizer 62 and the radiator 20. Therefore, heat management in the vehicle 500 using the heat exchanger can be appropriately performed.

(2-3) The controller 100 includes the processing circuitry 110. During the warm-up of the internal combustion engine 10, the processing circuitry 110 performs a process of controlling the multifunction valve 80 such that the amount of heat transferred between the vaporizer 62 and the waste heat recovery device 30 is larger than the amount of heat transferred between the vaporizer 62 and the radiator 20.

By executing such a process, the vaporization of the liquid hydrogen using the heat of the exhaust gas is prioritized during the warm-up of the internal combustion engine 10, so that the heat generated in the internal combustion engine 10 can be used for the warm-up of the internal combustion engine 10.

(2-4) The controller 100 includes the processing circuitry 110. When the internal combustion engine 10 is in a high load state, the processing circuitry 110 executes a process of controlling the multifunction valve 80 such that the amount of heat transferred between the vaporizer 62 and the radiator 20 is larger than the amount of heat transferred between the vaporizer 62 and the waste heat recovery device 30.

When the internal combustion engine 10 is in the high load state and the heat radiation demand of the engine increases, the amount of heat of the engine radiated via the vaporizer 62 increases by the execution of such processing. Therefore, the amount of heat radiated from the engine can be increased.

(2-5) The multiple heat exchangers include the oil cooler 50, which is a drive system heat exchanger that exchanges heat with the lubricating oil supplied to the transmission 40 of the vehicle 500.

Therefore, since heat can be exchanged between the oil cooler 50 and the vaporizer 62, the amount of heat radiated from the oil cooler 50 can be increased.

(2-6) The multifunction valve 80 is provided as a flow rate control mechanism for controlling the flow rate of the heat medium flowing through each passage. Therefore, it is possible to reduce the number of valves compared to a case where a valve is provided in each passage.

### Modifications

The above-described embodiments may be modified as follows. The above-described embodiments and the following modifications can be combined if the combined modifications remain technically consistent with each other.

The engine heat exchanger may be an oil cooler that cools lubricating oil of the internal combustion engine 10.

The heat medium may be a fluid other than cooling water.

The drive system heat exchanger described in the second embodiment may be other than the oil cooler 50 that cools the lubricating oil of the transmission 40. For example, an oil cooler that cools lubricating oil of a differential gear included in the vehicle 500 may be used.

In the second embodiment, the oil cooler 50 may be omitted.

In the first embodiment, the above-described drive system heat exchanger may be added as a device that performs heat exchange with the vaporizer 62.

The controller 100 is not limited to a device that includes a CPU and a memory and executes software processing. For example, the controller 100 may include hardware circuits, for example, an application-specific integrated circuit (ASIC), dedicated to executing at least part of the processes executed by the software in the above-described embodiment. That is, the controller 100 may be modified as long as it includes processing circuitry that has any one of the following configurations (a) to (c). (a) Processing circuitry including at least one processor that executes all of the above-described processes according to programs and at least one program storage device such as a ROM that stores the programs. (b) Processing circuitry including at least one processor and at least one program storage device that execute part of the above-described processes according to the programs and at least one dedicated hardware circuit that executes the remaining processes. (c) Processing circuitry including at least dedicated hardware circuit that executes all of the above-described processes. The program storage device, which is a computer-readable storage medium, includes any type of storage medium that is accessible by a general-purpose computer or a dedicated computer.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuitry are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A vehicle, comprising:
an internal combustion engine that uses hydrogen as fuel;
a fuel tank that stores liquid hydrogen;
a vaporizer that vaporizes the liquid hydrogen stored in the fuel tank;
multiple heat exchangers that exchange heat with the vaporizer;
passages that connect the vaporizer to the respective heat exchangers;
a flow rate control mechanism that controls a flow rate of a heating medium flowing through each passage; and
a controller that controls the flow rate control mechanism,
wherein the heat exchangers include:
an engine heat exchanger that exchanges heat with a fluid flowing through the internal combustion engine; and
a waste heat recovery device that exchanges heat with exhaust gas of the internal combustion engine.

2. The vehicle according to claim 1, wherein
the controller includes processing circuitry, and
the processing circuitry is configured to execute a process of controlling the flow rate control mechanism such that an amount of heat transferred between the vaporizer and the waste heat recovery device is larger than an amount of heat transferred between the vaporizer and the engine heat exchanger during warm-up of the internal combustion engine.

3. The vehicle according to claim 1, wherein
the controller includes processing circuitry, and
the processing circuitry is configured to execute a process of controlling the flow rate control mechanism such that an amount of heat transferred between the vaporizer and the engine heat exchanger is larger than an amount of heat transferred between the vaporizer and the waste heat recovery device when the internal combustion engine is in a high load state.

4. The vehicle according to claim 1, wherein
the engine heat exchanger is a radiator that cools cooling water of the internal combustion engine with ram air,
the flow rate control mechanism includes:
valves that selectively open and close the passages; and
a pump provided in the passage connecting the vaporizer and the radiator,
the controller includes processing circuitry, and
the processing circuitry is configured to execute, when the vehicle is traveling at a high speed, a process of controlling the valves such that the vaporizer exchanges heat with both the waste heat recovery device and the radiator, and a process of controlling a displacement of the pump such that the displacement of the pump is smaller than when the vehicle is not traveling at a high speed.

5. The vehicle according to claim 1, wherein the heat exchangers include a drive system heat exchanger that exchanges heat with a fluid supplied to a drive system mechanism of the vehicle.
